(19) United States
(12) Patent Application Publication
(10) Pub. No.: US 2004/0251277 A1
(43) Pub. Date: Dec. 16, 2004

(54) Water inlet and venting pipe of water dispenser

(76) Inventor: Chang Kuei Tang, Banchiau City (TW)

Correspondence Address: YI WEN TSENG, #D306, 509 ROOSEVELT BLVD., FALLS CHURCH, VA, 22044, US

(21) Appl. No.: 10/460,237

(22) Filed: Jun. 13, 2003

(51) Int. Cl. B67D 5/06

(52) U.S. Cl. 222/185.1

(57) ABSTRACT

A water inlet and venting pipe of a water dispenser. The venting pipe is installed in the water dispenser. The venting pipe is partitioned into water inlet channel and venting channel by a partitioning board integrally formed with the venting pipe. At least one inlet aperture is formed on the venting pipe for connecting the water inlet channel, while a venting aperture is formed on the venting pipe for connecting the venting channel. Thereby, air in the water inlet pipe is vented to from the water dispenser to the venting channel via the venting aperture, and water a tank installed on the water dispenser flows into the water dispenser via the inlet aperture and the water inlet channel. As the venting pipe includes the inlet channel and the venting channel are integrally formed, the manufacturing process is simple since only one mold is required and no special tooling is necessary. Further, the gauges of the inlet pipe and the venting pipe are fixed, such that the flow of water or air is more fluent.

### BACKGROUND OF THE INVENTION

The present invention relates generally to a water inlet and venting pipe of a water dispenser and, more particularly, to a water inlet and venting pipe that can be easily manufactured without using any special tooling for assembly, and provides fluent flow of air or water therein.

FIG. 1 shows a conventional water dispenser 10A, including an inversely disposed tank 20A and a water inlet and venting pipe 1A thereon. The top of the tank 20A is sealed with a cap 2A. Recessed from the center of the cap 2A is a hollow water guide 21A. A sealing cover 3A is disposed in the water guide 21A. Before the water tank 20A is installed in the water dispenser 10A, the cap 2A is sealed by the sealing cover 3A; and therefore, water in the tank 20A is prevented from flowing from the opening 22A through the water guide 21A. The sealing cover 3A also prevents objects entering the tank 20A to contaminate the water therein.

As shown in FIG. 2, the hollow water inlet and venting pipe 1A includes an outer pipe 11A and an inner pipe 12A disposed in the outer pipe 11A. The inner pipe 12A is connected to the outer pipe 11A by the fitting wings 13A formed at a bottom thereof. A venting channel 14A is formed between the outer pipe 1A and the inner pipe 12A, and a water inlet channel 15A is defined within the inner pipe 12A. As shown in FIG. 1, the flow communication between the upper portion of venting channel 14A and the upper portion of the water inlet channel 15A is blocked by a skirt bending from a top edge of the inner pipe 12A towards the outer pipe 11A. Above the skirt, a water inlet aperture 16A is formed on the outer pipe 11A to establish a channel towards the water inlet channel 15A, and under the skirt, a venting aperture 17A is formed on the outer pipe 11A to provide the connection for the venting channel 14A.

Referring to FIGS. 3 and 4, when the inversely disposed tank 20A is installed on the water dispenser 20A, that is, the top of the tank 20A is aligned over water inlet and venting pipe 1A, allowing the water inlet and venting pipe 1A inserted through the water guide 21A. By moving the tank 20A downwardly, the top portion of the water inlet and venting pipe 1A is in contact with the sealing cover 3A. A further downward movement of the tank 20A thus results in the removal of the sealing cover 3A from the water guide 21A and the upward movement of the water inlet and venting pipe 1A relative to the tank 20A. As a result, the sealing cover 3A and the upper portion of the water inlet and venting pipe 1A, including the water inlet aperture 16A and the venting aperture 17A are inserted into the tank 20A. Thereby, air in the water inlet and venting pipe 1A is vented from the venting hole 17A into the tank 20A, while water in the tank 20A flows into water dispenser 10A through the water inlet channel 15A of the water inlet channel 15A of the water inlet and venting pipe 1A.

The above water inlet and venting pipe 1A assembled by the outer pipe 11A and the inner pipe 12A requires two molds, which increase the inconvenience and cost. Further, additional tooling is required to assemble the outer pipe 11A and the inner pipe 12A together. In the case that the inner pipe 12A is not precisely positioned in the outer pipe, the flows of air and water are seriously affected.

### BRIEF SUMMARY OF THE INVENTION

The present invention provides a water inlet and venting pipe of a water dispenser, in which the water inlet and venting pipe is integrally formed to simplify the manufacturing process, so as to eliminate the requirement of tooling for assembly.

The present invention further provides a water inlet and venting pipe of a water dispenser that provides fluent flows of air or water therethrough.

The present invention is characterized in installing the water inlet and venting pipe on water dispenser and merging the water inlet and venting pipe with a cap sealing structure of the tank. The water inlet and venting pipe is partitioned into a water inlet channel and a venting channel. At least one water inlet aperture is formed on the water inlet and venting pipe to connect with the water inlet channel, and at least one venting aperture is formed on the water inlet and venting pipe to connect with the venting channel. Thereby, air is vented from the water inlet and venting pipe into the water tank, and water flows from the tank through the water inlet channel to be dispensed.

The present invention is characterized in forming a longitudinal partitioning board to partition the water inlet and venting pipe into a venting channel and a water inlet channel. Preferably, the capacity of the water inlet channel is larger than the venting channel. Three water inlet apertures are formed on the water inlet and venting pipe to connect the water inlet channel, and one venting aperture is formed on the water inlet and venting pipe to connect the venting channel.

In one embodiment of the present invention, the water inlet and venting pipe is integrally formed with a cross partitioning board therein. The elongate water inlet and venting pipe and the cross partitioning board define three elongate water inlet channels and one elongate venting channel. Similarly, three water inlet apertures are formed on the water inlet and venting pipe to connect the water inlet channels, and one venting aperture is formed on the water inlet and venting pie to connect the venting channel.

In one embodiment, the present invention further provides an extension pipe extending from a bottom of the water inlet channel to provide a more fluent water flow.

### BRIEF DESCRIPTION OF THE DRAWINGS

These, as well as other features of the present invention, will become more apparent upon reference to the drawings wherein:

FIG. 1 shows an exploded view of a conventional water dispenser and a water tank;

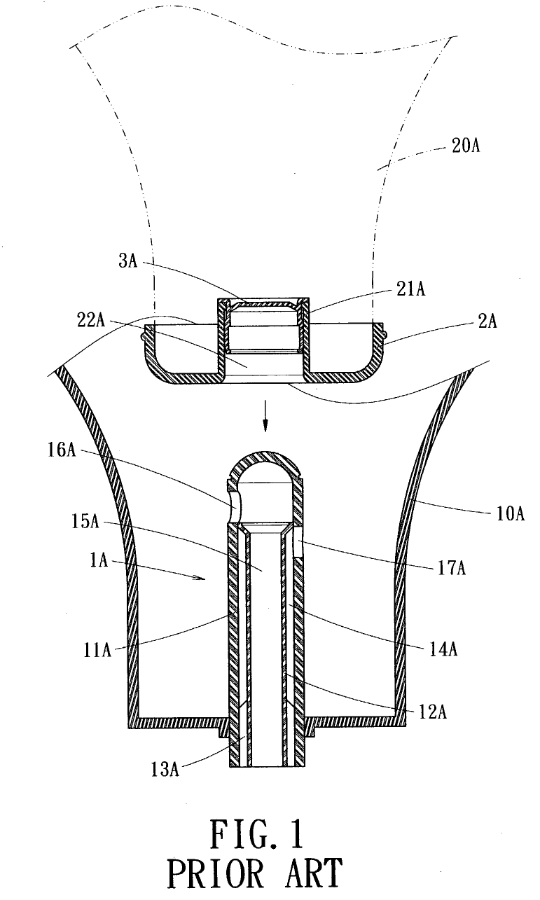

FIG. 2 is shows a perspective view of a water inlet and venting pipe of the conventional water dispenser;

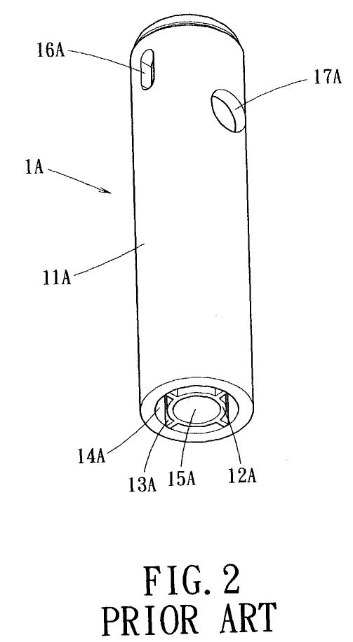

FIG. 3 shows the conventional water dispenser with the water tank disposed thereover;

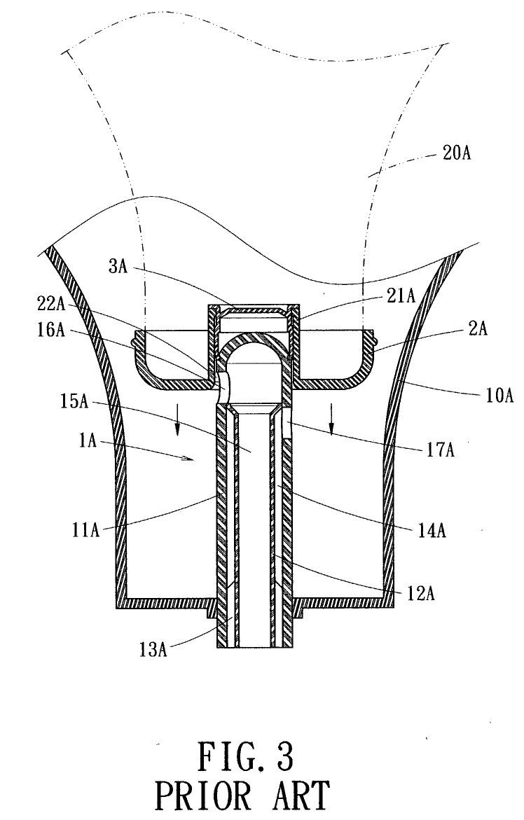

FIG. 4 shows the conventional water dispenser with the water tank installed thereon;

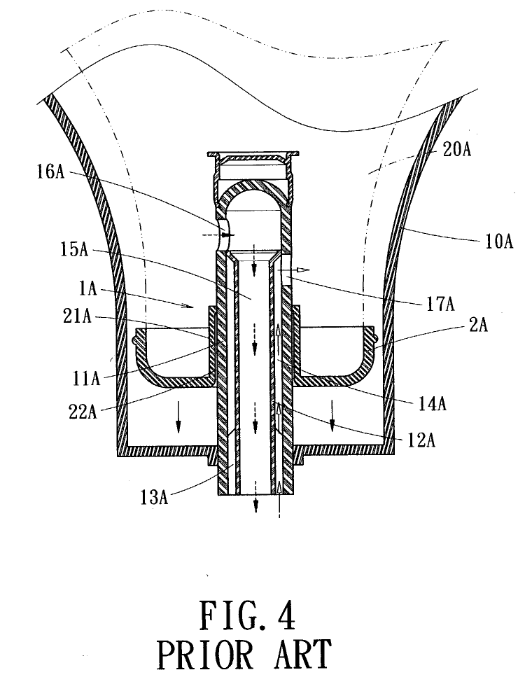

FIG. 5 shows a perspective view of a water inlet and venting pipe provided by the present invention;

FIG. 6 shows a cross-sectional view of the water inlet and venting pipe illustrated in FIG. 5;

FIG. 7 shows another embodiment of a water inlet and venting pipe provided by the present invention;

FIG. 8 shows a cross-sectional view of the water inlet and venting pipe illustrated in FIG. 7;

FIG. 9 shows an exploded view of a water dispenser and a water tank;

FIG. 10 shows the water dispenser with the water tank disposed thereover; and

FIG. 11 shows the water dispenser with the water tank installed thereon.

### DETAILED DESCRIPTION OF THE INVENTION

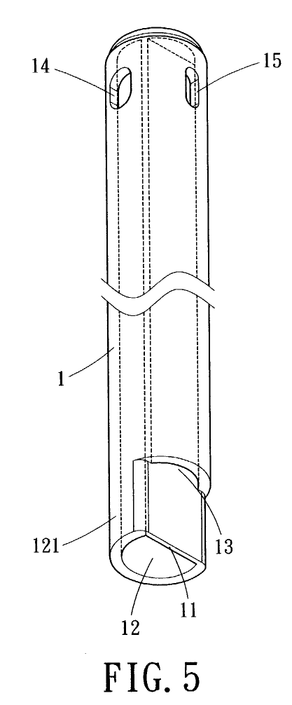

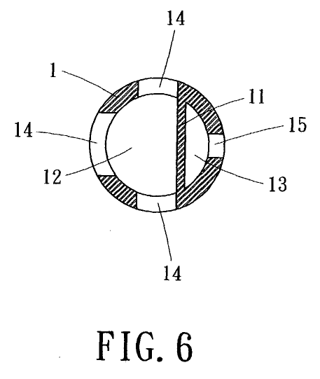

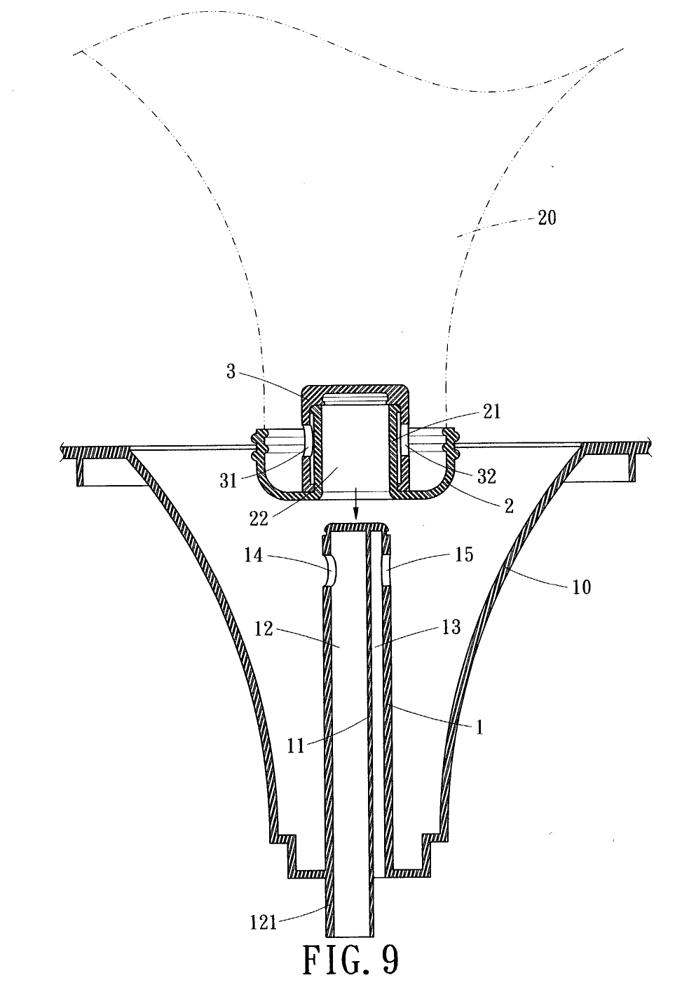

The present invention provides a water inlet and venting pipe of a water dispenser. Referring to FIG. 9, the water inlet and venting pipe 1 is installed in a water dispenser 10. When the water tank 20 is installed on the water dispenser 10, the sealing structure of the cap 2 of the water tank 20 is driven by the water inlet and venting pipe 1 to enter the water tank 20. As shown in FIGS. 5 and 6, the water inlet and venting pipe 1 includes an exterior cylindrical tube and an elongate partitioning board therein to define a water inlet channel 12 and a venting channel 13. In one embodiment, the water inlet and venting pipe 1 is so partitioned by the elongate partitioning board that the capacity of the water inlet channel 12 is larger than the venting channel 13. On the exterior cylindrical tube, three equidistant water inlet apertures 14 are formed to connect the water inlet channel 12, and one venting aperture 15 is formed to connect the venting channel 13. Preferably, the equidistant water inlet apertures 14 are formed at the same level.

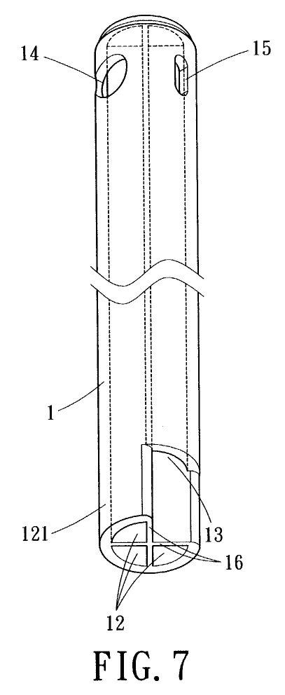

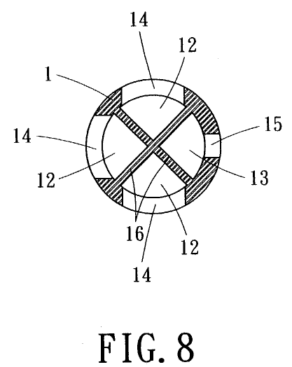

FIGS. 7 and 8 show another embodiment of the water inlet and venting pipe 1. Similarly, the water inlet and venting pipe 1 includes an elongate exterior tube and an elongate cross partitioning board 16 within the exterior tube. The exterior tube and the cross partitioning board 16 defines three water inlet channels 12 and one venting channel 13. The capacity of each water inlet channel 12 is the same as the capacity of the inlet channel 13. For each water inlet channel 12, one water inlet aperture 15 is formed on the corresponding portion of the exterior tube allowing water flowing into the water inlet channel 12. A venting aperture 15 is also formed on the portion of the exterior tube corresponding to the venting channel 13 allowing air to flow therefrom.

The above water inlet and venting pipe 1 has a close top end and an open bottom end. Preferably, an extension pipe 121 extends from the open bottom is included to improve the water flow along the water inlet channel 12.

As shown in FIG. 9, a water tank 20 to be installed on the water dispenser 10 is inversely disposed. A cap 2 is installed at the top of the water tank 20. A hollow guide 21 is recessed from the cap 2 to define an opening 22, allowing water to flow through. Before the water tank 20 is installed on the water dispenser 10, a sealing cover 3 is apply to seal the opening 22 of the cap 2.

In the present invention, a water outlet 31 and an air inlet 32 are formed on sidewall of the sealing cover 3. Before the water tank 20 is installed on the water dispenser 10, the water outlet 31 and the air inlet 32 are blocked by the guide 21, such that water is prevented from flowing through the opening 22.

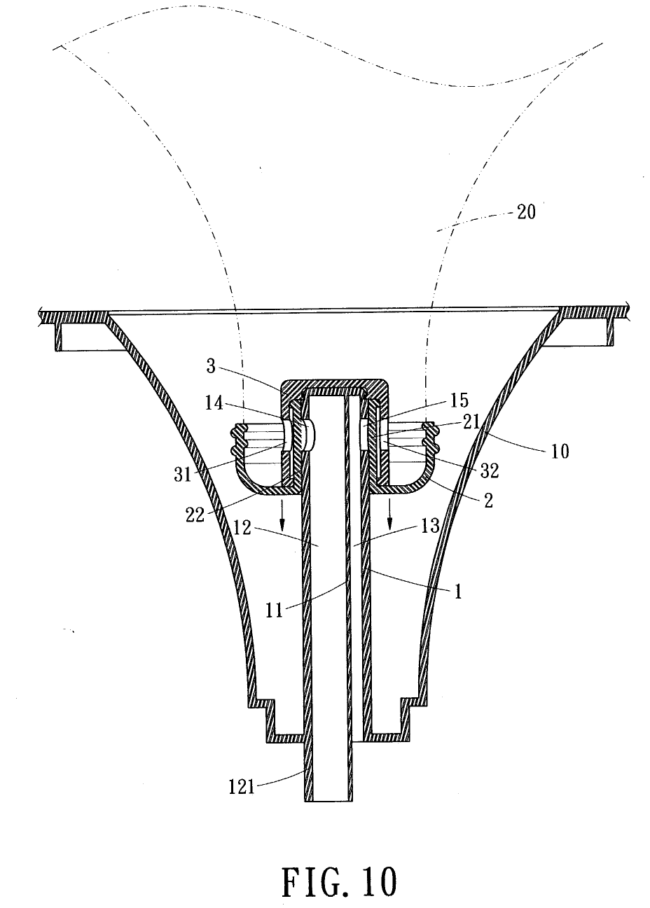

Referring to FIG. 9, to install the water tank 20 on the water dispenser 10, the water tank 20 is inversely disposed. The opening 22 defined by the guide 21 of the cap 2 is aligned over the water inlet and venting pipe 1 of the water dispenser 10. The water inlet and venting pipe 1 is then inserted into the guide 21 through opening 22. As shown in FIG. 10, once the top end of the water inlet and venting pipe 1 inserted into the guide 21 reaches the sealing cover 3, the sealing cover 3 is engaged with the water inlet and venting pipe 1.

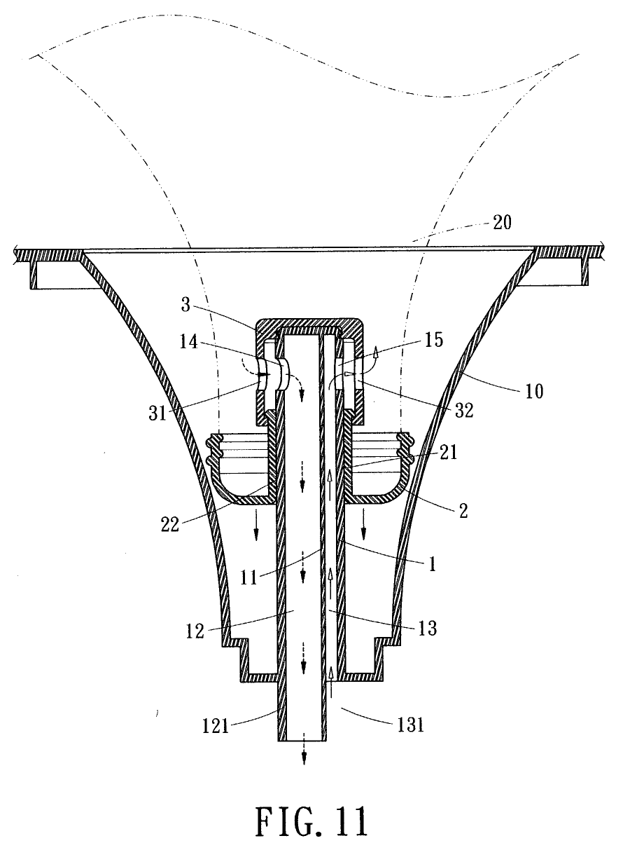

In FIG. 11, the water tank 20 is moved downwardly, such that the sealing cover 3 engaged with the water inlet and venting pipe 1 is pushed upwardly relative to the guide 21 of the cap 2. As water tank 20 moves further downwardly, the sealing cover 3 is no longer overlapped with the guide 21. Instead, the top portion of the sealing cover 3 is at a higher level compared to the top portion of the guide 21. In this embodiment, latching structures such as barbs are formed along the bottom edge of the sealing cover 3 and the top edge of the guide 21. Therefore, when the water tank 20 is installed in the water dispenser 10, the top portion of the sealing cover 3 attached to the top portion of the water inlet and venting pipe 1 is pushed upwardly relative to the cap 2, while the cap 2 is driven upwardly into the water tank 20 by the latching structures latching the bottom edge of the sealing cover 3 with the top edge of the guide 22. As the cap 2 is drawn downwardly from the sealing cover 3 and the guide 22 and the sealing cover 3 are staggered from each other, the water outlet 31 and the air inlet 32 can be aligned with the water inlet aperture 14 and the venting aperture 15 of the water inlet and venting pipe 1, respectively.

When the water tank 20 is properly installed in the water dispenser 10 as shown in FIG. 11, air is vented from the venting channel 13 to the water tank 20 via the venting aperture 15 and the air inlet 32. Meanwhile, water contained in the water tank 20 flows through the water outlet 31, the water inlet aperture 14, and the water inlet channel 12 to be dispensed from the water dispenser 10.

Accordingly, the present invention has at least the following advantages:

1. The water inlet and venting pipe and the partitioning board are integrally formed to define the water inlet channel 12 and the venting channel 13, such that only one mold is required, and the manufacturing process is simplified.

2. As the water inlet and venting pipe and the partitioning board therein are integrally formed as a unitary structure, no additional tooling is required for assembly.

3. The capacities of the water inlet channel 12 and the venting channel 13 are constant, such that the air or water flow through the water inlet and venting pipe 1 is much more fluently.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A water inlet and venting pipe in a water dispenser, comprising:
a partitioning board to define at least one water inlet channel and a venting channel in the water inlet and venting pipe;
wherein the partitioning board is integrally formed with the water inlet and venting pipe, and the water inlet and venting pipe further comprises a first water inlet aperture and a venting aperture to connect the water inlet channel and the venting channel, respectively.

2. The water inlet and venting pipe of claim 1 is in a form of cylindrical tube.

3. The water inlet and venting pipe of claim 1, wherein the partitioning board is so configured that the water inlet channel is larger than the venting channel.

4. The water inlet and venting pipe of claim 1, further comprising a second aperture and a third aperture connecting the water inlet channel, wherein the first, second and third apertures are equidistant to each other.

5. The water inlet and venting pipe of claim 4, wherein the first, second and third apertures are level to each other.

6. The water inlet and venting pipe of claim 1, wherein the partitioning board includes a cross cross-section to define three water inlet channels and the venting channel, and the capacity of each water inlet channel is the same as that of the venting channel.

7. The water inlet and venting pipe of claim 6, wherein the water inlet pipe comprises one water inlet aperture for each water inlet channel.

8. The water inlet and venting pipe of claim 1, comprising a close top and an open bottom end.

9. The water inlet and venting pipe of claim 1, further comprising an extension pipe extending from the bottom end thereof.
